(19) United States
(12) Patent Application Publication
(10) Pub. No.: US 2018/0212894 A1
(43) Pub. Date: Jul. 26, 2018

(54) FORK TRANSFER OF DATA BETWEEN MULTIPLE AGENTS WITHIN A RECONFIGURABLE FABRIC

(71) Applicant: Wave Computing, Inc., Campbell, CA (US)

(72) Inventors: Christopher John Nicol, Campbell, CA (US); Sam Brandon Sandbote, San Jose, CA (US)

(21) Appl. No.: 15/924,873

(22) Filed: Mar. 19, 2018

Related U.S. Application Data
(63) Continuation-in-part of application No. 15/904,724, filed on Feb. 26, 2018.
Application No. 15/904,724 is a continuation-in-part of application No. 15/226,472, filed on Aug. 2, 2016.
Application No. 15/226,472 is a continuation-in-part of application No. 15/665,631, filed on Aug. 1, 2017.
(60) Provisional application No. 62/637,614, filed on Mar. 2, 2018.
(60) Provisional application No. 62/636,309, filed on Feb. 28, 2018.
(60) Provisional application No. 62/464,119, filed on Feb. 27, 2017.
(60) Provisional application No. 62/200,069, filed on Aug. 2, 2015.
(60) Provisional application No. 62/611,600, filed on Dec. 29, 2017.
(60) Provisional application No. 62/611,588, filed on Dec. 29, 2017.
(60) Provisional application No. 62/594,563, filed on Dec. 5, 2017.
(60) Provisional application No. 62/594,582, filed on Dec. 5, 2017.
(60) Provisional application No. 62/579,616, filed on Oct. 31, 2017.
(60) Provisional application No. 62/577,902, filed on Oct. 27, 2017.
(60) Provisional application No. 62/547,769, filed on Aug. 19, 2017.
(60) Provisional application No. 62/541,697, filed on Aug. 5, 2017.
(60) Provisional application No. 62/539,613, filed on Aug. 1, 2017.
(60) Provisional application No. 62/382,750, filed on Sep. 1, 2016.
(60) Provisional application No. 62/527,077, filed on Jun. 30, 2017.
(60) Provisional application No. 62/486,204, filed on Apr. 17, 2017.
(60) Provisional application No. 62/472,670, filed on Mar. 17, 2017.

(51) Int. Cl. H04L 12/863; H04L 12/861

(52) U.S. Cl. CPC H04L 47/6245; H04L 47/6225; H04L 49/90

(57) ABSTRACT

Techniques are disclosed for managing data within a reconfigurable computing environment. In a multiple processing element environment, such as a mesh network, or other suitable topology, there is a need to pass data between processing elements. In many instances when multiple processing elements are working together to perform a given task, it is desirable to improve parallelism where possible to decrease overall execution time. An upstream processing element performs a fork operation to provide data to multiple downstream processing elements. The processing elements within the reconfigurable fabric are controlled by circular buffers. The circular buffers are statically scheduled. The fork operation provides for computation to be divided amongst multiple processing elements. An efficient forking mechanism is a key component in achieving optimal performance of a multiple processing element system.

### RELATED APPLICATIONS

This application claims the benefit of U.S. provisional patent applications “Fork Transfer of Data Between Multiple Agents Within a Reconfigurable Fabric” Ser. No. 62/472,670, filed Mar. 17, 2017, “Reconfigurable Processor Fabric Implementation Using Satisfiability Analysis” Ser. No. 62/486,204, filed Apr. 17, 2017, “Joining Data Within a Reconfigurable Fabric” Ser. No. 62/527,077, filed Jun. 30, 2017, “Remote Usage of Machine Learned Layers by a Second Machine Learning Construct” Ser. No. 62/539,613, filed Aug. 1, 2017, “Reconfigurable Fabric Operation Linkage” Ser. No. 62/541,697, filed Aug. 5, 2017, “Reconfigurable Fabric Data Routing” Ser. No. 62/547,769, filed Aug. 19, 2017, “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, and “Dynamic Reconfiguration Using Data Transfer Control” Ser. No. 62/637,614, filed Mar. 2, 2018.

This application is also a continuation-in-part of U.S. patent application “Communication between Dataflow Processing Units and Memories” Ser. No. 15/665,631 filed Aug. 1, 2017, which claims the benefit of U.S. provisional patent application “Communication between Dataflow Processing Units and Memories” Ser. No. 62/382,750, filed Sep. 1, 2016.

This application is also a continuation-in-part of U.S. patent application “Data Flow Computation Using FIFOs” Ser. No. 15/904,724, filed Feb. 26, 2018, which claims the benefit of U.S. provisional patent applications “Data Flow Computation Using FIFOs” Ser. No. 62/464,119, filed Feb. 27, 2017, “Fork Transfer of Data Between Multiple Agents Within a Reconfigurable Fabric” Ser. No. 62/472,670, filed Mar. 17, 2017, “Reconfigurable Processor Fabric Implementation Using Satisfiability Analysis” Ser. No. 62/486,204, filed Apr. 17, 2017, “Joining Data Within a Reconfigurable Fabric” Ser. No. 62/527,077, filed Jun. 30, 2017, “Remote Usage of Machine Learned Layers by a Second Machine Learning Construct” Ser. No. 62/539,613, filed Aug. 1, 2017, “Reconfigurable Fabric Operation Linkage” Ser. No. 62/541,697, filed Aug. 5, 2017, “Reconfigurable Fabric Data Routing” Ser. No. 62/547,769, filed Aug. 19, 2017, “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, and “Multithreaded Dataflow Processing Within a Reconfigurable Fabric” Ser. No. 62/611,600, filed Dec. 29, 2017.

The patent application “Data Flow Computation Using FIFOs” Ser. No. 15/904,724, filed Feb. 26, 2018 is also a continuation-in-part of U.S. patent application “Data Transfer Circuitry Given Multiple Source Elements” Ser. No. 15/226,472, filed Aug. 2, 2016, which claims the benefit of U.S. provisional patent application “Data Uploading to Asynchronous Circuitry Using Circular Buffer Control” Ser. No. 62/200,069, filed Aug. 2, 2015.

Each of the foregoing applications is hereby incorporated by reference in its entirety.

### FIELD OF ART

This application relates generally to logic circuitry and more particularly to fork transfer of data between multiple agents within a reconfigurable fabric.

### BACKGROUND

Multiple processing elements can be used to process data in a coordinated manner to perform tasks for a variety of applications. Such applications can include networking, image processing, simulations, and signal processing, to name a few. As semiconductor technology improves, there has been a corresponding increase in computing power and reduction in average computing cost. In addition to increased computing power, greater flexibility is also important for adapting to ever-changing business needs and technical situations. The demand for increased computing power to implement newer electronic designs for a variety of applications such as computing, networking, communications, consumer electronics, and data encryption, is continuously growing in today's modern computing world. In addition to processing speed, configuration flexibility is a key attribute in modern computing systems. Multiple core processor designs enable two or more cores to run simultaneously, and the combined throughput of the multiple cores can easily exceed the processing power of a single-core processor. In accordance with implications of Moore's Law, multiple core capacity allows for an increase in capability of electronic devices without hitting boundaries that would be encountered if attempting to implement similar processing power using a single core processor.

In multiple processing element systems, the processing elements communicate with each other, exchanging and combining data to produce intermediate and/or final outputs. Each processing element can have a variety of registers to support program execution and storage of intermediate data. Additionally, registers such as stack pointers, return addresses, and exception data can further enable execution of complex routines and support debugging of computer programs running on the multiple processing elements. Furthermore, arithmetic units can provide mathematical functionality, such as addition, subtraction, multiplication, and division.

One architecture for use with multiple processing elements is a mesh network. A mesh network is a network topology containing multiple interconnected processing elements. The processing elements work together to distribute and process data. This architecture allows for a degree of parallelism for processing data, enabling increased performance. Additionally, the mesh network allows for a variety of configurations.

Reconfigurability is an important attribute in many processing applications, as reconfigurable devices have proven to be extremely efficient for certain types of processing tasks. In certain circumstances, the cost and performance advantages of reconfigurable devices derive from reconfigurable logic which enables program parallelism. This parallelism allows multiple simultaneous computation operations to occur for the same program. Meanwhile, conventional processors are often limited by instruction bandwidth and execution restrictions. Typically, the high-density properties of reconfigurable devices come at the expense of the high-diversity property that is inherent in microprocessors. Microprocessors have evolved to a highly-optimized configuration that can provide cost/performance advantages over reconfigurable arrays for certain tasks with high functional diversity. However, there are many tasks for which a conventional microprocessor may not be the best design choice. An architecture supporting configurable interconnected processing elements can be a viable alternative in certain applications.

The emergence of reconfigurable computing has enabled a higher level of both flexibility and performance of computer systems. Reconfigurable computing combines the high speed of application-specific integrated circuits with the flexibility of programmable processors. This provides much-needed functionality and power to enable the technology used in many current and upcoming fields.

### SUMMARY

Disclosed techniques implement data manipulation with logic circuitry. One or more processing elements are arranged in a connected topology. A first-in-first-out (FIFO) buffer is dynamically configured between an upstream processing element and a plurality of downstream processing elements. The FIFO buffer contains data and/or instructions for processing elements. A process agent executing on the upstream processing element performs a fork operation to coordinate the transfer of data between the upstream and downstream processing elements via a FIFO. In some embodiments, each downstream processing element may have its own input FIFO. The fork operation enables a higher level of parallelism that can improve overall system performance.

Embodiments include a processor-implemented method for data manipulation comprising: linking a first control agent to a plurality of other control agents, wherein the first control agent and the plurality of other control agents are each executed on a processing element controlled by a circular buffer, and wherein the processing elements comprise a reconfigurable fabric; sending data from the first control agent to the plurality of other control agents, wherein: the data is sent to the plurality of other control agents in parallel; and employing a FIFO between the first control agent and the plurality of other control agents to facilitate the sending.

In embodiments, the sending includes transferring the data from the FIFO to a second control agent, wherein the second control agent is part of the plurality of other control agents. In embodiments, the sending also includes transferring the data from the FIFO to a third control agent, wherein the third control agent is part of the plurality of other control agents. In embodiments, the FIFO comprises a first multicast FIFO and a second multicast FIFO, wherein: data from the first control agent is sent to the first multicast FIFO and the second multicast FIFO in parallel; data from the first multicast FIFO is sent to the second control agent using a first head address and a first tail address; and data from the second multicast FIFO is sent to the third control agent using the first head address and a second tail address.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for data manipulation.

FIG. 2 is a flow diagram for agent control.

FIG. 3 shows process agents configured for a fork operation.

FIG. 4 illustrates pseudocode for fork agent 1.

FIG. 5 shows writes to FIFOs using network multicast.

FIG. 6 illustrates additional pseudocode for fork agent 1.

FIG. 7 shows scheduled sections relating to an agent.

FIG. 8 illustrates a server allocating FIFOs and processing elements.

FIG. 9 shows a cluster for coarse-grained reconfigurable processing.

FIG. 10 illustrates a block diagram of a circular buffer.

FIG. 11 illustrates a circular buffer and processing elements.

FIG. 12 is a system diagram for implementing transfers between agents in reconfigurable fabric.

### DETAILED DESCRIPTION

Techniques are disclosed for managing data within a reconfigurable computing environment, such as a reconfigurable fabric. In a multiple processing element environment, such as a mesh network or other suitable topology, there is an inherent need to pass data between and among processing elements. In many instances where multiple processing elements are working together to perform a given task, it is desirable to improve parallelism wherever possible to decrease overall execution time. The more computations that are done in parallel, the greater economy of execution time can be achieved. In some cases, subtasks may be divided amongst multiple processing elements. In such cases, a fork operation can be used to pass data to multiple downstream processing elements simultaneously. An efficient forking mechanism is a key factor in achieving optimal performance of a multiple processing element system.

An agent executing in software on each processing element interacts with dynamically established first-in-first-out (FIFO) buffers to coordinate the flow of data. The size of each FIFO may be created at run-time based on latency and/or synchronization requirements for a particular application. Registers within each processing element track the starting address and ending address of each FIFO. In cases where there is no data present in a FIFO, a processing element can enter a sleep mode to save energy. When valid data arrives in a FIFO, a sleeping processing element can wake and process the data.

Based on the data consumption and production rates of each processing element, an additional FIFO may be established between two processing elements. In some cases, a processing element may produce small amounts of data at low intervals, in which case no FIFO may be needed, and the processing element can send the data directly to another processing element. In other cases, a processing element may produce large amounts of data at frequent intervals, in which case an additional FIFO can help streamline the flow of data. This can be particularly important with bursty data production and/or bursty data consumption. In some embodiments, the data may be divided into blocks of various sizes. Data blocks above a predetermined threshold may be deemed as large blocks. For example, blocks greater than 512 bytes may be considered large blocks in some embodiments. Large data blocks may be routed amongst processing elements through FIFOs implemented as a memory element in external memory, while small data blocks (less than or equal to the predetermined threshold) may be passed amongst processing elements directly into onboard circular buffers without requiring a FIFO.

The FIFO size can include a variable width. In some cases, the FIFO entry width can vary on an entry-by-entry basis. Depending on the type of data read from and written to the FIFO, a different width can be selected in order to optimize FIFO usage. For example, 8-bit data would fit more naturally in a narrower FIFO, while 32-bit data would fit more naturally in a wider FIFO. The FIFO width may also account for tags, metadata, pointers, and so on. The width of the FIFO entry can be encoded in the data that will flow through the FIFO. In this manner, the FIFO size may change in width based on the encoding. In embodiments, the FIFO size includes a variable width. In embodiments, the width is encoded in the data flowing through the FIFO.

In a multiple processing element environment, data from a first processing element is sent to two downstream processing elements simultaneously as part of a forking operation. In embodiments, a FIFO is configured between the first processing element and the downstream processing elements. Each downstream processing element can access the FIFO independently. The consumption rate of each downstream FIFO may differ. Data signals may be sent between the first processing element and the downstream processing elements to coordinate the data exchange with the FIFO. In other embodiments, each downstream processing element has its own dedicated FIFO. Thus, the first processing element sends data to one FIFO when it is destined for one of the downstream processing elements and sends the data to another FIFO when it is destined for a different downstream processing element. In this way, there is additional flexibility in the forking operation in terms of data consumption and production rates of the various processing elements.

The forking operation within a network of processing elements enables improved efficiency. It serves to minimize the amount of down time for processing elements by increasing the parallelism of the computations, allowing the processing elements to continue producing, and/or consuming data as much as possible during operation of the multiple processing element computer system. This efficiency accrues even when the processing elements are spatially separate from each other, that is, when they are not one of the nearest neighbors of each other.

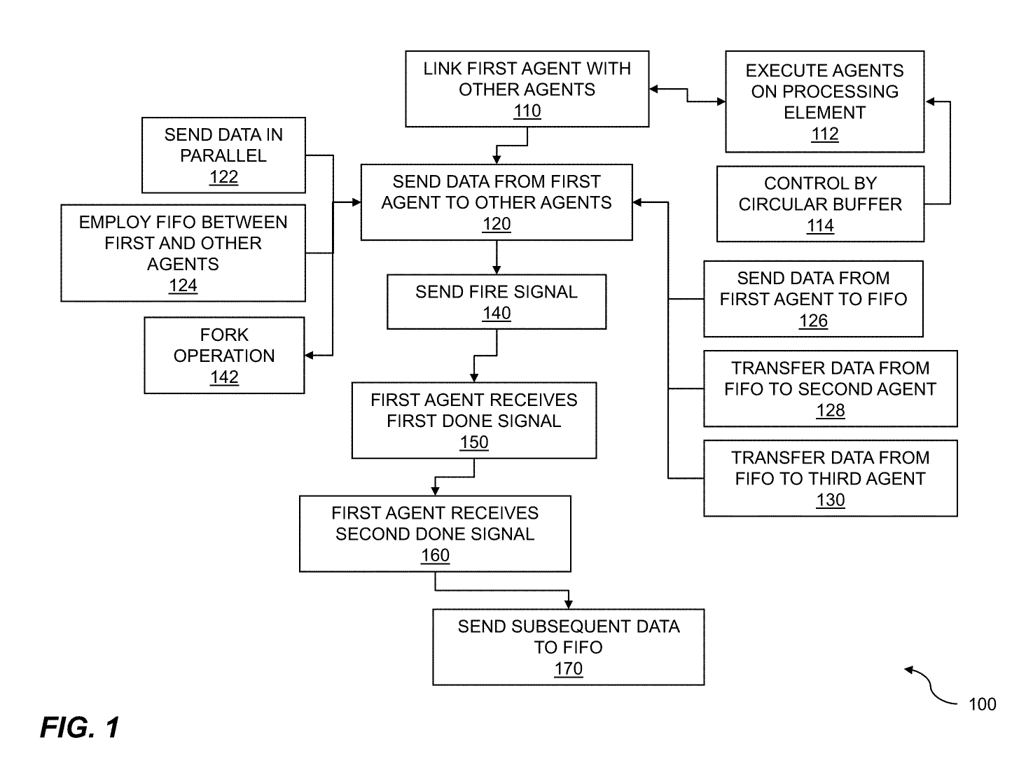

FIG. 1 is a flow diagram 100 for data manipulation. The flow 100 illustrates a processor-implemented method for data manipulation. The flow 100 includes linking a first control agent with a plurality of other control agents 110, wherein the first control agent and the plurality of other control agents are each executed on a processing element 112 controlled by a circular buffer 114. Each circular buffer can be loaded with a page of instructions which configures the digital circuit operated upon by the instructions in the circular buffer. When and if a digital circuit is required to be reconfigured, a different page of instructions can be loaded into the circular buffer and can overwrite the previous page of instructions that was in the circular buffer. A given circular buffer and the circuit element which the circular buffer controls can operate independently from other circular buffers and their concomitant circuit elements. The circular buffers and circuit elements can operate in an asynchronous manner. That is, the circular buffers and circuit elements can be self-clocked, self-timed, etc., and require no additional clock signal. Further, swapping out one page of instructions for another page of instructions does not require a retiming of the circuit elements. The circular buffers and circuit elements can operate as hum circuits, where a hum circuit is an asynchronous circuit that operates at its own resonant or “hum” frequency. In embodiments, each of the plurality of processing elements can be controlled by a unique circular buffer. Thus, in some cases, the initial configuration of the circular buffers may be established at compile time.

In embodiments, the linking may be based on a dataflow graph (DFG). The dataflow graph can be an intermediate representation of a design. The dataflow graph may be processed as an input by an automated tool such as a compiler. The output of the compiler may include instructions for reconfiguring processing elements to perform as process agents. The reconfiguring can also include insertion of a FIFO between two processing elements of a plurality of processing elements.

A FIFO is employed between the first control agent and other control agents 124. The first agent may be referred to as an upstream agent, and the plurality of other control agents may be referred to as downstream agents. The upstream agent sends data to multiple downstream agents via a fork operation 142. Thus, in embodiments, sending data comprises a fork operation. In embodiments, the fork operation is a simultaneous fork operation, and data is sent from the upstream agent to the plurality of downstream agents simultaneously. Thus, in embodiments, the data is sent to the plurality of other control agents in parallel 122. In some embodiments, a FIFO is employed between the first control agent and each of the plurality of other control agents 124 to facilitate the sending.

The FIFO may be sized dynamically. One criterion for FIFO size selection may be the consumption rate of the process agent. The consumption rate of the process agent pertains to the rate at which the process agent can read input data from a FIFO. The consumption rate can be related to the functions performed by a processing element. If a processing element performs minimal data manipulation, then the consumption rate may be relatively high. If a processing element performs more extensive data manipulation (e.g. more operations), it may be that then the consumption rate is relatively low. A lower consumption rate may warrant a larger input FIFO, whereas a higher consumption rate may allow for a smaller input FIFO, since the process agent removes data from the FIFO more quickly, and thus requires less memory.

Another criterion for the FIFO size selection includes the production rate of the process agent. The production rate of the process agent pertains to the rate at which the process agent can write input data to a FIFO. The production rate can be related to the functions performed by a processing element. If a processing element performs minimal data manipulation, then the production rate may be relatively high. If a processing element performs more extensive data manipulation (e.g. more operations) then the production rate may be relatively low. A lower production rate may allow for a smaller output FIFO, whereas a higher production rate may warrant a larger output FIFO, since the process agent places data on the FIFO more quickly, thus requiring more memory.

The flow 100 includes sending data from the first control agent to the plurality of other control agents 120. In embodiments, this includes transferring data from a first control agent (upstream agent) to a FIFO 126, transferring data from the FIFO to a second control agent (a downstream agent) 128, and also transferring data from the FIFO to a third control agent (another downstream agent) 130. In embodiments, the sending includes transferring the data from a first control agent to the FIFO. Furthermore, in embodiments, the sending includes transferring the data from the FIFO to a second control agent, wherein the second control agent is part of the plurality of other control agents. Furthermore, in embodiments, the sending also includes transferring the data from the FIFO to a third control agent, wherein the third control agent is part of the plurality of other control agents.

Synchronization between upstream and downstream agents can be enabled using fire and/or done signals. The first process agent can issue a first fire signal to the downstream agents when the first process agent has completed a first data transfer into the FIFO. Similarly, the downstream agents may each send a done signal to the first process agent (upstream agent) once the downstream agents have emptied the FIFO contents (retrieved all available data from the FIFO). In embodiments, the fire signals and done signals may be implemented by dedicated hardware Input/Output (I/O) signals between two processing elements. In other embodiments, fire and done signals may be implemented as an instruction passed directly to a circular buffer of a neighboring processing element.

The fork operation outlined in the flow 100 enables increased parallelism in execution of a function by providing increased data transfer to multiple processing elements. The flow 100 includes sending a fire signal 140 from the first control agent to the second control agent and the third control agent, wherein the fire signal indicates to the second control agent and the third control agent that the data in the FIFO is ready for use. The flow 100 includes sending subsequent data to the FIFO from the first control agent 170 after the first done signal 150 and the second done signal 160 have both been received. The process thus continues as new data is transferred from the upstream agent to the downstream agents. Embodiments may include receiving a first done signal by the first control agent from the second control agent, wherein the first done signal indicates that the second control agent no longer needs the data in the FIFO. Embodiments may further include receiving a second done signal by the first control agent from the third control agent, wherein the second done signal indicates that the third control agent no longer needs the data in the FIFO. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

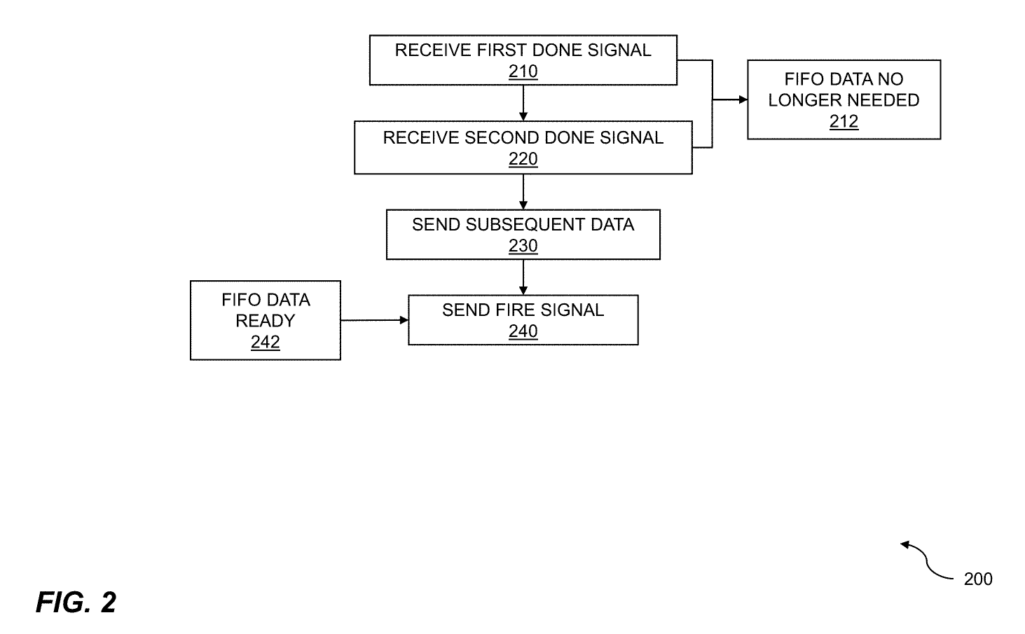

FIG. 2 is a flow diagram for agent control. The flow 200 includes transferring the data from a first control agent to the FIFO. The flow 200 includes receiving a first done signal by the first control agent 210 from the second control agent, wherein the first done signal indicates that the second control agent no longer needs the data in the FIFO 212. This can be used as a form of synchronization between processing elements. The flow 200 includes receiving a second done signal by the first control agent 220 from the third control agent, wherein the second done signal indicates that the third control agent no longer needs the data in the FIFO 212. The done signals serve as an indication that the data in the FIFO can be safely overwritten with new data. The flow 200 continues with sending subsequent data 230 from the upstream agent to the FIFO. Once data is written to the FIFO, a FIFO data ready 242 condition occurs, and the flow 200 continues with sending a fire signal 240 to the downstream agents. The downstream agents can then retrieve the new data from the FIFO, and the process continues. Thus, embodiments include sending a fire signal from the first control agent to the second control agent and the third control agent, wherein the fire signal indicates to the second control agent and the third control agent that the data in the FIFO is ready for use.

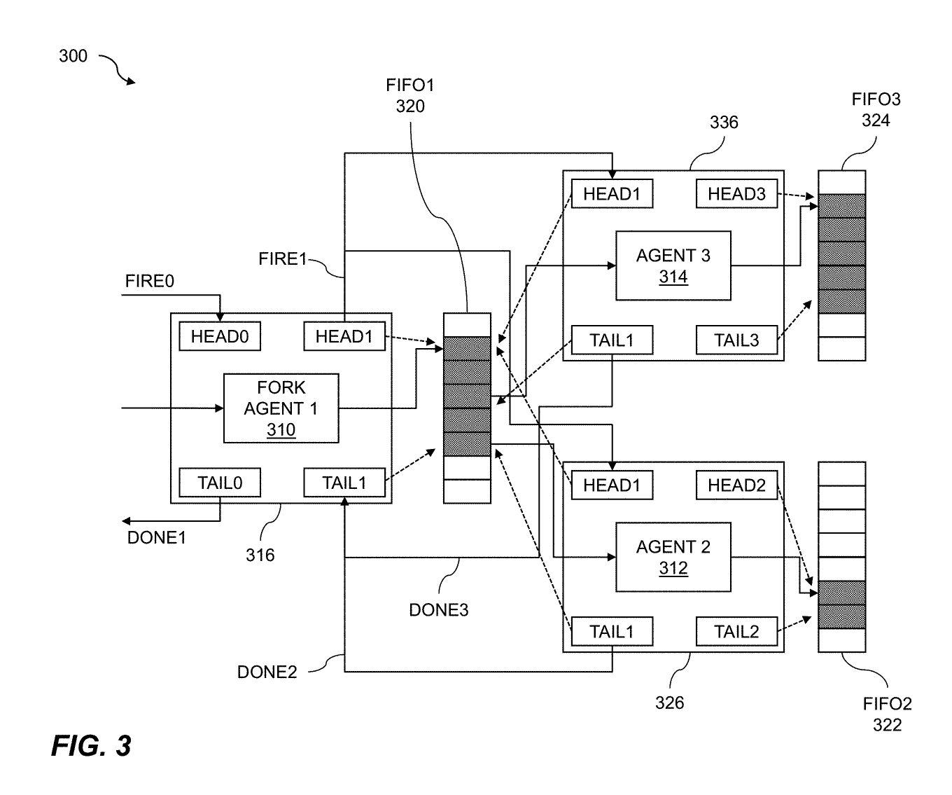

FIG. 3 shows an example 300 with a pipeline of process agents configured for a fork operation. The example 300 includes a first processing element 316, a second processing element 326, and a third processing element 336. A first process agent, fork agent 310, executes on processing element 316. A second process agent 312 executes on processing element 326. A third process agent 314 executes on processing element 336. A FIFO 320 (FIFO1) is configured between processing element 316 and processing elements 326 and 336.

In embodiments, data flows from processing element 316 to FIFO1 320, and then to both processing element 326 and processing element 336. Each processing element comprises a plurality of head and tail registers for coordinating read and write access of the FIFO 320. In the example 300, agent 312 (AGENT2) receives data from agent 310 (AGENT1) through FIFO1 320 and delivers data downstream to subsequent agents (not shown) through FIFO2 322. Thus, AGENT2 is seen to have one input stream. In embodiments, AGENT2 can have an additional input stream from another agent (not shown) through an additional FIFO (not shown) in similar manner to the input stream from AGENT1 310 through FIFO1 320, already described. In this case, AGENT2 312 can wait for valid data to be present in both of its input FIFOs before commencing operation. AGENT2 312 can wait for sufficient space on its output FIFO2 322 before commencing operation. In embodiments, data transfer into a processing element with two input streams is held pending until data on both input streams is valid. In embodiments, data transfer into a processing element with two input streams is held pending until space exists on an output FIFO.

In the diagram 300, the FIFOs can comprise blocks of memory designated by starting addresses and ending addresses. The respective HEAD and TAIL registers/pointers of each processing element can be configured to reference the starting and ending addresses respectively. The starting addresses and the ending addresses can be stored with instructions in circular buffers. In embodiments, as agents executing on the processing elements place data in a FIFO or remove data from a FIFO, a corresponding read and write pointer or register is updated to refer to the next location to be read to or written from. In embodiments, as agents executing on the processing elements place data on a FIFO or remove data from a FIFO, the head and/or tail pointer/register is updated to refer to the next location to be read to or written from.

The first FIFO can enable synchronization between the first and second process agents. The second FIFO can enable synchronization between the second and third process agents. In embodiments, signaling between the processing elements can be used to enable synchronization. The second process agent can issue a first done signal to the first process agent when the second process agent has completed a first data transfer out of the first FIFO. Similarly, the third process agent can issue a second done signal to the second process agent when the third process agent has completed a second data transfer out of the second FIFO.

Synchronization can also be enabled using fire signals. The first process agent can issue a first fire signal to the second process agent when the first process agent has completed a first data transfer into the first FIFO. Similarly, the second process agent can issue a second fire signal to the third process agent when the second process agent has completed a second data transfer into the second FIFO.

For synchronization purposes, the first processing element 316 sends a fire signal (FIRE1) to the downstream processing elements 326 and 336, indicating the availability of data in FIFO1 320. The downstream processing elements 326 and 336 then simultaneously retrieve data from FIFO1 320, process the data, and output results to their respective output FIFOs. Processing element 326 outputs data to FIFO2 322. Processing element 336 outputs data to FIFO3 324. Processing element 326 may have a different data consumption rate than processing element 336. Thus, each downstream processing element has a corresponding done signal to indicate completion of reading data from the input FIFO, in this case FIFO1 320. Processing element 326 issues signal DONE2 to the first processing element 316. Processing element 336 issues signal DONE3 to the first processing element 316. When the agent 310 executing on processing element 316 receives both done signals, the agent 310 can place new input data on FIFO1 320 for a fork operation to distribute the data to the multiple downstream processing elements 326 and 336. Additionally, to support the potentially different data consumption rates of processing element 326 and processing element 336, each processing element has its own input FIFO pointers (READ1 and TAIL1) to track the current location of available data within the input FIFO, as shown by FIFO1 320. The upstream processing element 316 has a HEAD0 and TAIL0 pointer to receive data from an upstream FIFO (not shown). Furthermore, processing element 326 has pointers HEAD2 and TAIL2 for managing data transfer to output FIFO2 322, and processing element 336 has pointers HEAD3 and TAIL3 for managing data transfer to output FIFO3 324. In embodiments, the head and tail pointers for each processing element may be implemented as registers within the processing element.

The HEAD0 register of processing element 316 and the HEAD1 register of processing element 326 and the READ1 register of processing element 336 may be synchronized to each point to a starting address of FIF01 320. FIFO2 322 and FIFO3 324 may be of different sizes. As indicated in FIG. 3, FIFO2 322 is allocated to include two blocks of memory (indicated by shaded blocks within FIFO2 322) and FIFO3 is allocated to include five blocks of memory (indicated by the shaded blocks within FIFO3 324). Thus, the first size and the second size can be different. The first size can be bigger based on output data rates and/or latency requirements of the first process agent and the second process agent.

Thus, disclosed embodiments provide a configuration of multiple processing elements configured to perform a fork operation between an upstream processing element and multiple downstream processing elements. This facilitates improved parallelism and increased data processing throughput. Note that while two downstream processing elements (326 and 336) are shown in FIG. 3, in practice, a fork operation can be performed between more than two processing elements. For example, there can be four, eight, or some other number of processing elements receiving data from FIF01 320 as a result of a fork operation. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

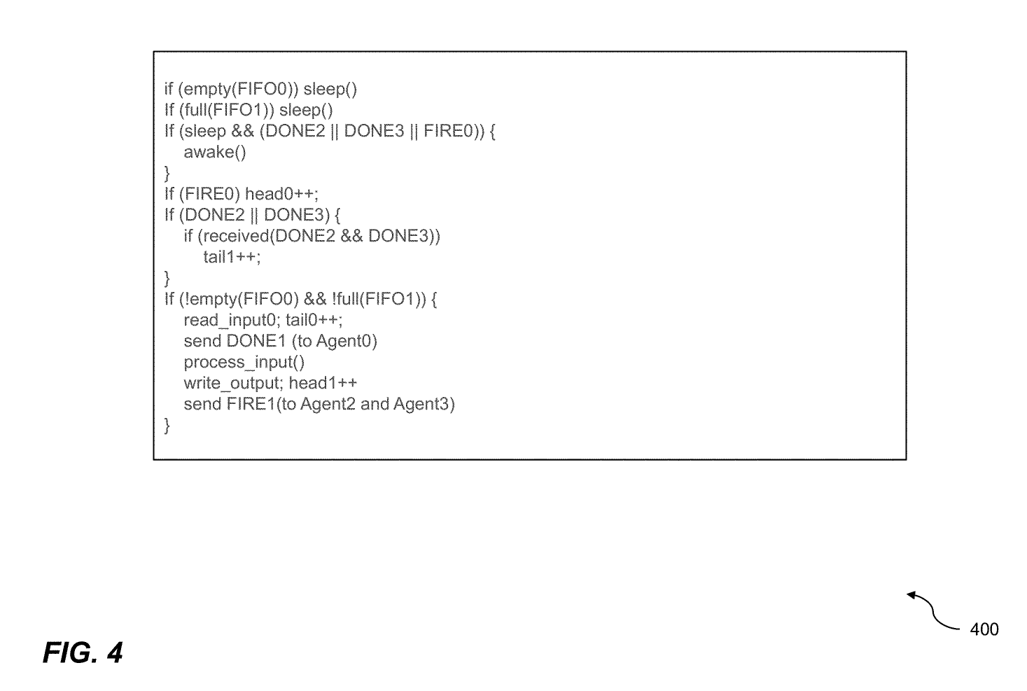

FIG. 4 illustrates an example 400 of pseudocode for fork agent 310 of FIG. 3. A plurality of process agents can be triggered by start instructions stored in circular buffers. A processing element, upon detecting a start instruction, can invoke the process agent to begin a fork operation, thereby enabling synchronization between neighboring processing elements. The pseudocode can include logic for checking if an input FIFO is empty and causing it to enter sleep mode if the input FIFO is empty. In the pseudocode, FIFO0 represents an input FIFO (not shown) for processing element 316 of FIG. 3. Thus, in the example of FIG. 3, processing element 316 can enter a sleep mode if its input FIFO is empty. The sleep mode can be a low power mode. The low power mode can be a mode operating at a reduced clock speed and/or reduced voltage. The pseudocode can include logic for checking if its output FIFO1 320 is full and causing it to enter sleep mode if the output FIFO is full. Thus, in the example of FIG. 3, processing element 316 can enter a sleep mode if FIFO1 320 is full. The pseudocode can include logic to check for the presence of a FIRE signal or DONE signal and to transition from a sleep mode to an awake state upon detecting such a condition.

Referring again to the example of FIG. 3, processing element 316 can transition to an awake state from a sleep mode upon detecting an asserted FIRE0 signal originating from an upstream processing element (not shown), which indicates that new data is available for processing element 316.

Similarly, processing element 316 can transition to an awake state from a sleep state upon detecting an asserted DONE2 signal originating from processing element 326, and/or a DONE3 signal originating from processing element 336, which indicates that the downstream processing elements are ready to accept more data placed in FIFO1 320. The pseudocode can include logic for incrementing a head/tail pointer/register based on the presence of a FIRE signal or DONE signal.

The pseudocode can further include logic for recording performance information. The performance information can later be used by tools such as compilers, and/or interpreted by engineers to make improvements in a reconfigurable processing network. For example, the performance information can include, but is not limited to, average sleep mode percentage, average sleep mode percentage due to input FIFO empty, and average sleep mode percentage due to output FIFO full. The performance information can further include a comparison of data processing rates of each of the downstream processing elements. Ideally, the downstream processing elements should have similar, but not necessarily identical processing rates. In some embodiments, if the data consumption rates of the downstream processing elements are significantly different, a warning may be provided to a user/designer to evaluate if a fork operation with a single buffer configuration is optimal for that particular situation. In some cases, a reconfiguration of the processing elements may improve performance.

In this way, as a reconfigurable fabric is used with live data, the statistics can be studied to determine if additional adjustments can further optimize the performance. As an example, an output FIFO size may be increased if it is determined that a processing element is spending considerable time in sleep mode due to the output FIFO being full. In some embodiments, the reconfigurable processing network may be simulated on one or more computers, and the results of the simulation may be used to further optimize the selection of FIFO sizes used in the actual hardware platform.

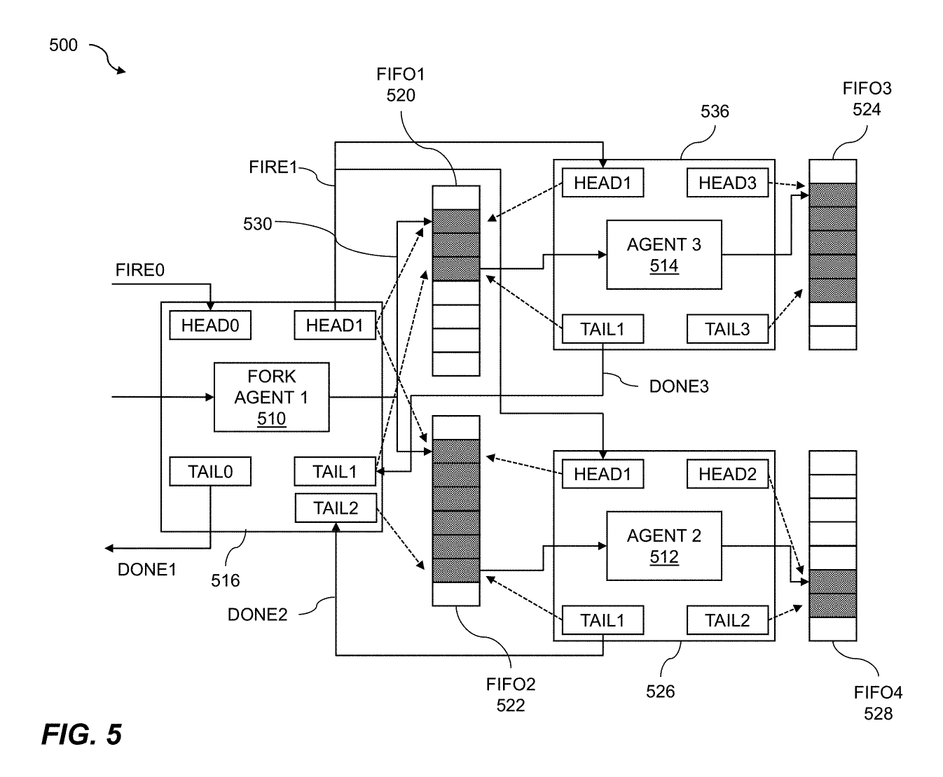

FIG. 5 shows writing to FIFOs using network multicast. Data is sent on a multicast node 530 to multiple FIFOs which then provide the data to respective receiving processing elements. The example 500 shows FIFOs for forking comprising a first multicast FIFO 520 and a second multicast FIFO 522. An upstream processing element 516 multicasts data to FIFO 520 and FIFO 522. Processing element 526 reads data from FIFO2 522, processes the data, and outputs results to FIFO4 528. Similarly, processing element 536 retrieves data from FIFO1 520, processes it, and outputs results to FIFO3 524. Processing element 516 executes a fork agent 510. Processing element 526 executes control agent 512, and processing element 536 executes control agent 514. Data from the fork agent 510 is sent to the first multicast FIFO 520 and the second multicast FIFO 522 in parallel.

In this arrangement, each downstream processing element has its own input FIFO. This allows for greater flexibility in the data consumption rates of the downstream agents. For example, if downstream processing element 526 has a slower consumption rate than processing element 536, it may be possible for the upstream processing element 516 to continue providing new data to FIFO1 520 for processing element 536 to consume while waiting for processing element 526 to consume its input data from FIFO2 522. In embodiments, the upstream processing element 516 that executes the fork agent 510 provides two tail pointers (TAIL1 and TAIL2). The use of two tail pointers allows tracking of the current tail position of each of the multicast FIFOs independently. Thus, in embodiments, data from the first multicast FIFO is sent to the second agent 512 using a first head address and a first tail address. Thus, in embodiments, the data that is transferred to the FIFO starts at a head address within the FIFO. Similarly, in embodiments, data from the second multicast FIFO2 522 is sent to the third agent 514 using the first head address and a second tail address. In embodiments, the data that is transferred to the FIFO ends at a tail address within the FIFO. In some embodiments, the head address and the tail address are different. In some embodiments, the tail address is greater than the head address. In some embodiments, the first tail address and the second tail address are different. This can accommodate different consumption schedules or rates from the downstream FIFOs.

In some embodiments, a spatial separation exists between the agents receiving the forked data. For example, agent 512, executed on processing element 526, can be physically distant within a reconfigurable fabric from agent 514, executed on processing element 536. The separation can be enabled because reading data on a FIFO can be blocked, such that only the read can take place. A write operation can be non-blocking, and therefore the network can duplicate the data from the forking agent to be used in multiple, spatially separate agents. Of course, while only two agents are shown receiving forked data in the example of FIG. 5, more than two agents can be accommodated by the current invention.

In some embodiments, the data that is transferred from the FIFO to the second control agent starts at a first head address within the FIFO and ends at a first tail address within the FIFO. In some embodiments, the data that is transferred from the FIFO to the third control agent starts at a second head address within the FIFO and ends at a second tail address within the FIFO. In some embodiments, the first head address is the same as the second head address. In some embodiments, the first tail address is the same as the second tail address. In some embodiments, the first tail address is different from the second tail address. In some embodiments, the first head address and the first tail address comprise pointers for the second control agent. In some embodiments, the second head address and the second tail address comprise pointers for the third control agent. In some embodiments, the pointers for the second control agent and the pointers for the third control agent are different. In some embodiments, the FIFO comprises a first multicast FIFO and a second multicast FIFO, wherein: data from the first agent is sent to the first multicast FIFO and the second multicast FIFO in parallel; data from the first multicast FIFO is sent to the second agent using a first head address and a first tail address; and data from the second multicast FIFO is sent to the third agent using the first head address and a second tail address. In some embodiments, the first tail address and the second tail address are different.

Disclosed embodiments provide a configuration of multiple processing elements configured to perform a fork operation between an upstream processing element and multiple downstream processing elements where multiple multicast FIFOs are used by the fork agent to distribute data to downstream control agents in parallel. This facilitates improved parallelism and increased data processing throughput. Note that while two downstream processing elements (526 and 536) are shown in FIG. 5, in practice, a fork operation can be performed between more than two processing elements. Furthermore, there can be more than two multicast FIFOs that receive data from the fork agent 510. For example, in embodiments, the upstream processing element 516 can simultaneously write data to four, eight, or another number of multicast FIFOs simultaneously. As shown in FIG. 5, there is a one-to-one relationship between the multicast FIFOs and the respective downstream processing elements. For example, FIFO 522 only inputs data to processing element 526, and FIFO 520 only inputs data to processing element 536. However, in some embodiments, there can be a one-to-X relationship between the multicast FIFOs and the respective downstream processing elements, where X is greater than one. For example, each multicast FIFO can input to two or more downstream processing elements in some embodiments. A wide variety of configurations are possible.

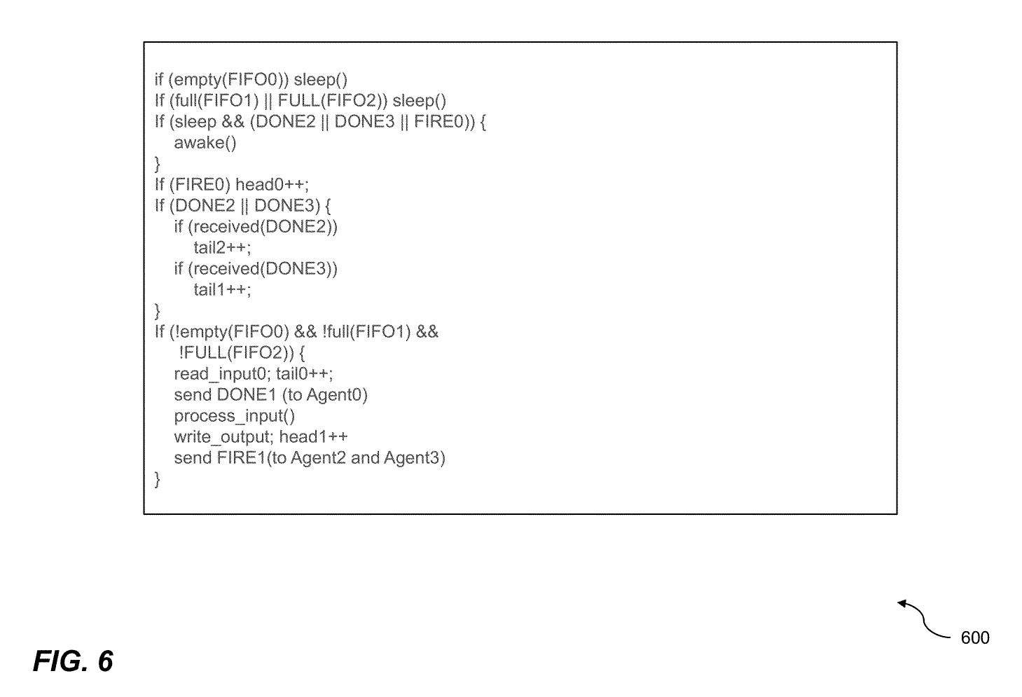

FIG. 6 illustrates an example 600 of pseudocode for fork agent 510 of FIG. 5. A plurality of control agents can be triggered by start instructions stored in circular buffers. A processing element, upon detecting a start instruction, can invoke the control agent to begin a fork operation, thereby enabling synchronization between neighboring processing elements. The pseudocode is similar to the example 400 shown in FIG. 4, with the addition of support for the two tail pointers tail1 and tail2 to be incremented independently based on done signals. The tail2 pointer is updated if a DONE2 signal is received from processing element 526. Similarly, the tail1 pointer is incremented if a DONE3 signal is received from processing element 536. While the embodiments disclosed in FIG. 5 and FIG. 6 use more resources (e.g. FIFO) memory than the embodiments disclosed in FIG. 3 and FIG. 4, the embodiments disclosed in FIG. 5 and FIG. 6 can also provide more performance and flexibility due to the independent processing of data within the multicast FIFOs.

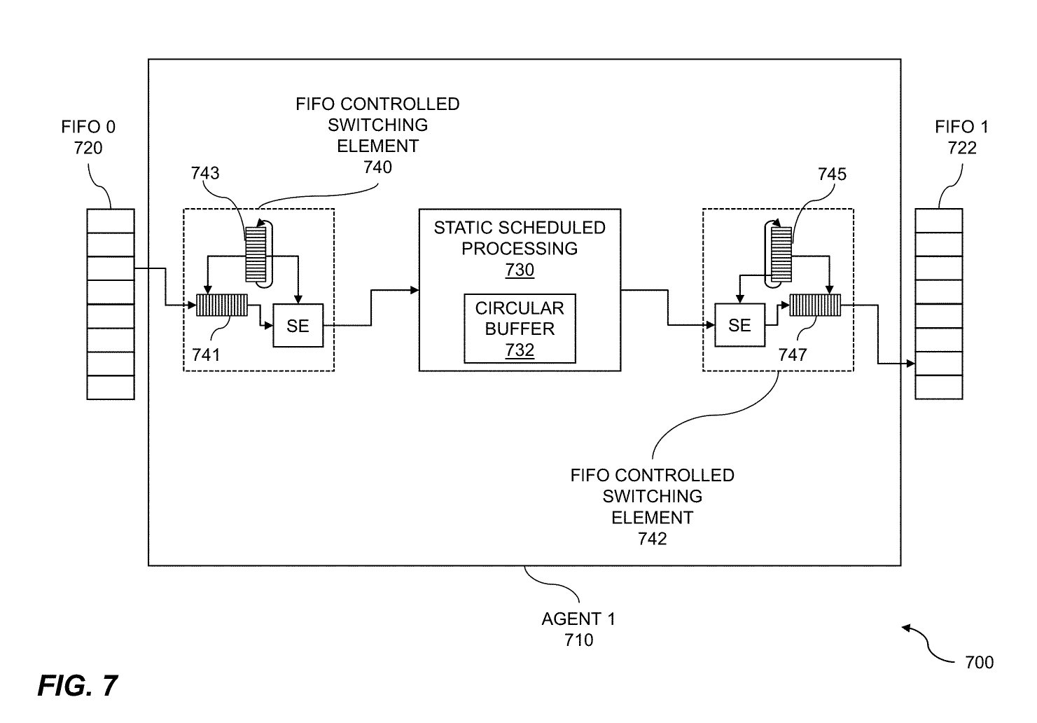

FIG. 7 shows an example 700 of scheduled sections relating to an agent. A FIFO 720 serves as an input FIFO for a process agent 710. Data from FIFO 720 is read into local buffer 741 of a FIFO controlled switching element 740. Circular buffer 743 may contain instructions that are executed by a switching element (SE), and may modify data based on one or more logical operations, including, but not limited to, XOR, OR, AND, NAND, and/or NOR. The plurality of processing elements can be controlled by circular buffers. The modified data may be passed to a circular buffer 732 under static scheduled processing 730. Thus, the scheduling of circular buffer 732 may be performed at compile time. The circular buffer 732 may provide data to a FIFO controlled switching element 742. Circular buffer 745 may rotate to provide a plurality of instructions/operations to modify and/or transfer data to data buffer 747 which is then transferred to an external FIFO 722.

A process agent can include multiple components. An input component handles retrieval of data from an input FIFO. For example, agent 710 receives input from FIFO 720. An output component handles the sending of data to an output FIFO. For example, agent 710 provides data to FIFO 722. A signaling component can signal to process agents executing on neighboring processing elements about conditions of a FIFO. For example, a process agent can issue a FIRE signal to another process agent operating on another processing element when new data is available in a FIFO that was previously empty. Similarly, a process agent can issue a DONE signal to another process agent operating on another processing element when new space is available in a FIFO that was previously full. In this way, the process agent facilitates communication of data and FIFO states amongst neighboring processing elements to enable complex computations with multiple processing elements in an interconnected topology.

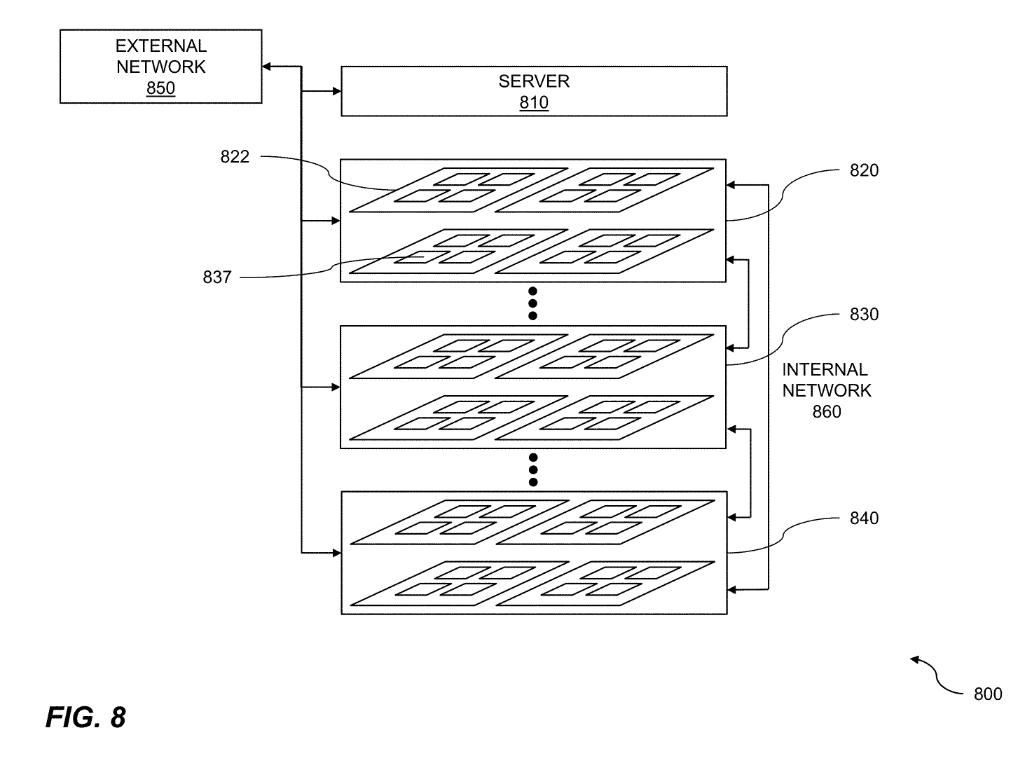

FIG. 8 illustrates an example of a system 800 including a server 810 allocating FIFOs and processing elements. In embodiments, system 800 includes one or more boxes, indicated by callouts 820, 830, and 840. Each box may have one or more boards, indicated generally as 822. Each board comprises one or more chips, indicated generally as 837. Each chip may include one or more processing elements, where at least some of the processing elements may execute a process agent. An internal network 860 allows communication between the boxes such that processing elements on one box can provide and/or receive results from processing elements on another box.

The server 810 may be a computer executing programs on one or more processors based on instructions contained in a non-transitory computer readable medium. The server 810 may perform reconfiguring of a mesh networked computer system comprising a plurality of processing elements with a FIFO between one or more pairs of processing elements. In some embodiments, each pair of processing elements has a dedicated FIFO configured to pass data between the processing elements of the pair. The server 810 may receive instructions and/or input data from external network 850. The external network may provide information that includes, but is not limited to, hardware description language instructions (e.g. Verilog, VHDL, or the like), flow graphs, source code, or information in another suitable format.

The server 810 may collect performance statistics on the operation of the collection of processing elements. The performance statistics can include average sleep time of a processing element, and/or a histogram of the sleep time of each processing element. Any outlier processing elements that sleep longer than a predetermined threshold can be identified. In embodiments, the server can resize FIFOs or create new FIFOs to reduce the sleep time of a processing element that exceeds the predetermined threshold. Sleep time is essentially time when a processing element is not producing meaningful results, so it is generally desirable to minimize the amount of time a processing element spends in a sleep mode. In some embodiments, the server 810 may serve as an allocation manager to process requests for adding or freeing FIFOs, and/or changing the size of existing FIFOs in order to optimize operation of the processing elements.

In some embodiments, the server may receive optimization settings from the external network 850. The optimization settings may include a setting to optimize for speed, optimize for memory usage, or balance between speed and memory usage. Additionally, optimization settings may include constraints on the topology, such as a maximum number of paths that may enter or exit a processing element, maximum data block size, and other settings. Thus, the server 810 can perform a reconfiguration based on user-specified parameters via the external network 850.

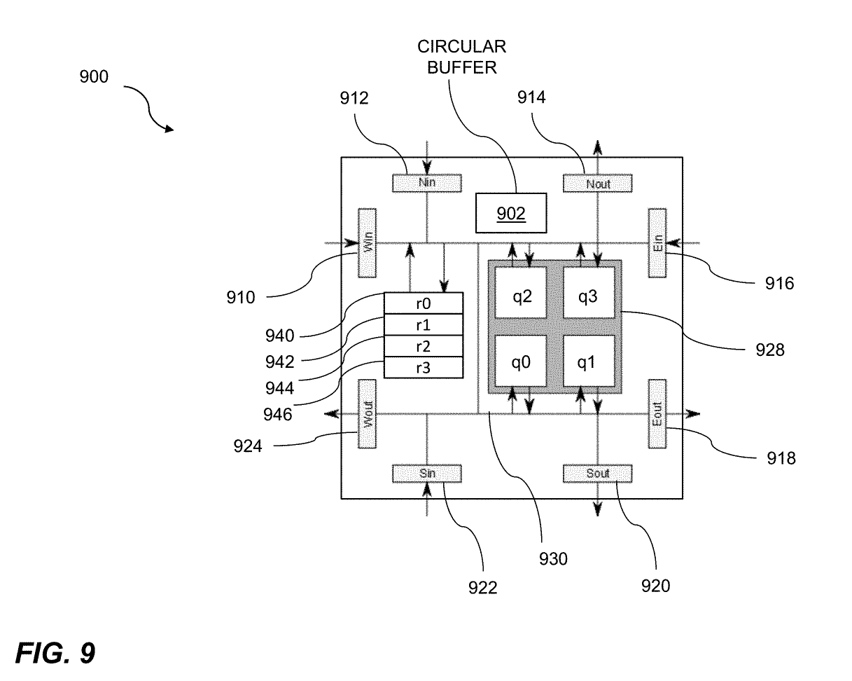

FIG. 9 is an example cluster 900 for coarse-grained reconfigurable processing. Data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The cluster 900 comprises a circular buffer 902. The circular buffer 902 can be referred to as a main circular buffer or a switch-instruction circular buffer. In some embodiments, the cluster 900 comprises additional circular buffers corresponding to processing elements within the cluster. The additional circular buffers can be referred to as processor instruction circular buffers. The example cluster 900 comprises a plurality of logical elements, configurable connections between the logical elements, and a circular buffer 902 controlling the configurable connections. The logical elements can further comprise one or more of switching elements, processing elements, or storage elements. The example cluster 900 also comprises four processing elements—q0, q1, q2, and q3. The four processing elements can collectively be referred to as a “quad,” and can be jointly indicated by a grey reference box 928. In embodiments, there is intercommunication among and between each of the four processing elements. In embodiments, the circular buffer 902 controls the passing of data to the quad of processing elements 928 through switching elements. In embodiments, the four processing elements 928 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 900 can further comprise storage elements coupled to the configurable connections. As shown, the cluster 900 comprises four storage elements—r0 940, r1 942, r2 944, and r3 946. The cluster 900 further comprises a north input (Nin) 912, a north output (Nout) 914, an east input (Ein) 916, an east output (Eout) 918, a south input (Sin) 922, a south output (Sout) 920, a west input (Win) 910, and a west output (Wout) 924. The circular buffer 902 can contain switch instructions that implement configurable connections. For example, an instruction effectively connects the west input 910 with the north output 914 and the east output 918 and this routing is accomplished via bus 930. The cluster 900 can further comprise a plurality of circular buffers residing on a semiconductor chip where the plurality of circular buffers control unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 902. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 924 to an instruction placing data on the south output 920, such that the data can be output on both output ports within the same pipeline cycle. In a case where data needs to travel to a cluster that is both south and west of the cluster 900, it can be more efficient to send the data directly to the south output port rather than storing the data in a register first, and then sending the data to the west output on a subsequent pipeline cycle.

An L2 switch interacts with the instruction set. A switch instruction typically has a source and a destination. Data is accepted from the source and sent to the destination. There are several sources (e.g. any of the quads within a cluster, any of the L2 directions (North, East, South, West), a switch register, one of the quad RAMs (data RAM, IRAIVI, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in too many instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can implement any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A”, to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running, or while the processors are in a low power “sleep” state. Accesses to the instruction RAMs and the PE and Co-Processor Registers may be performed during configuration mode. The quad RAMs may have a single read/write port with a single address decoder, thus allowing their access to be shared by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

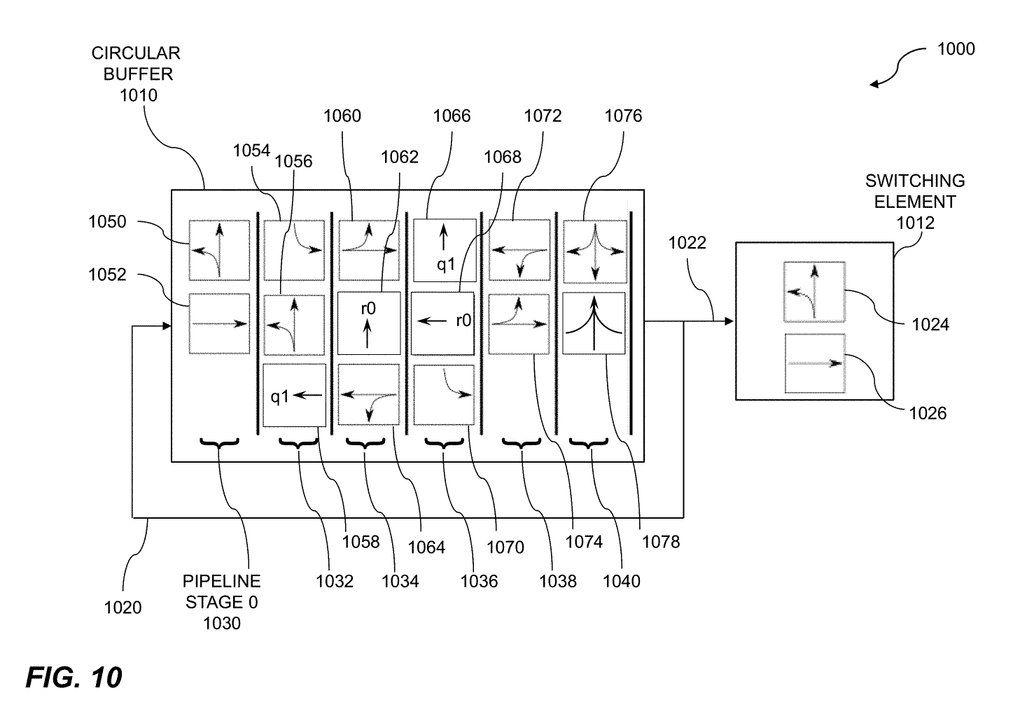

FIG. 10 shows a block diagram of a circular buffer. The circular buffer 1010 can include a switching element 1012 corresponding to the circular buffer. The circular buffer and the corresponding switching element can be used in part for dynamic reconfiguration with partially resident agents. Using the circular buffer 1010 and the corresponding switching element 1012, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 1000 describes a processor-implemented method for data manipulation. The circular buffer 1010 contains a plurality of pipeline stages. Each pipeline stage contains one or more instructions, up to a maximum instruction depth. In the embodiment shown in FIG. 10, the circular buffer 1010 is a 6×3 circular buffer, meaning that it implements a six-stage pipeline with an instruction depth of up to three instructions per stage (column). Hence, the circular buffer 1010 can include one, two, or three switch instruction entries per column. In some embodiments, the plurality of switch instructions per cycle can comprise two or three switch instructions per cycle. However, in certain embodiments, the circular buffer 1010 supports only a single switch instruction in a given cycle. In the block diagram example 1000 shown, Pipeline Stage 0 1030 has an instruction depth of two instructions 1050 and 1052. Though the remaining pipeline stages 1-5 are not textually labeled in FIG. 10, the stages are indicated by callouts 1032, 1034, 1036, 1038, and 1040. Pipeline stage 1 1032 has an instruction depth of three instructions 1054, 1056, and 1058. Pipeline stage 2 1034 has an instruction depth of three instructions 1060, 1062, and 1064. Pipeline stage 3 1036 also has an instruction depth of three instructions 1066, 1068, and 1070. Pipeline stage 4 1038 has an instruction depth of two instructions 1072 and 1074. Pipeline stage 5 1040 has an instruction depth of two instructions 1076 and 1078. In embodiments, the circular buffer 1010 includes 64 columns. During operation, the circular buffer 1010 rotates through configuration instructions. The circular buffer 1010 can dynamically change operation of the logical elements based on the rotation of the circular buffer. The circular buffer 1010 can comprise a plurality of switch instructions per cycle for the configurable connections.

The instruction 1052 is an example of a switch instruction. In embodiments, each cluster has four inputs and four outputs, each designated within the cluster's nomenclature as “north,” “east,” “south,” and “west” respectively. For example, the instruction 1052 in the block diagram 1000 is a west-to-east transfer instruction. The instruction 1052 directs the cluster to take data on its west input and send out the data on its east output. In another example of data routing, the instruction 1050 is a fan-out instruction. The instruction 1050 instructs the cluster to take data from its south input and send out the data through both its north output and its west output. The arrows within each instruction box indicate the source and destination of the data. The instruction 1078 is an example of a fan-in instruction. The instruction 1078 takes data from the west, south, and east inputs and sends out the data on the north output. Therefore, the configurable connections can be considered to be time multiplexed.

In embodiments, the clusters implement multiple storage elements in the form of registers. In the block diagram example 1000 shown, the instruction 1062 is a local storage instruction. The instruction 1062 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is completed. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep as the cluster awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 1058 is a processing instruction. The instruction 1058 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 1000 shown, the circular buffer 1010 rotates instructions in each pipeline stage into switching element 1012 via a forward data path 1022, and also back to a pipeline stage 0 1030 via a feedback data path 1020. Instructions can include switching instructions, storage instructions, and processing instructions, among others. The feedback data path 1020 can allow instructions within the switching element 1012 to be transferred back to the circular buffer. Hence, the instructions 1024 and 1026 in the switching element 1012 can also be transferred back to pipeline stage 0 as the instructions 1050 and 1052. In addition to the instructions depicted on FIG. 10, a no-op instruction can also be inserted into a pipeline stage. In embodiments, a no-op instruction causes execution to not be performed for a given cycle. In effect, the introduction of a no-op instruction can cause a column within the circular buffer 1010 to be skipped in a cycle. By contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs causing the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 1058, assuming that the processor q1 was previously in a sleep state. In embodiments, when the instruction 1058 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 1066. In the case of the instruction 1066, data from the processor q1 is moved to the north output. In some embodiments, if Xs have been placed into the processor q1, such as during the instruction 1058, then Xs would be retrieved from the processor q1 during the execution of the instruction 1066 and would be applied to the north output of the instruction 1066.

A collision occurs if multiple instructions route data to a particular port in a given pipeline stage. For example, if instructions 1052 and 1054 are in the same pipeline stage, they will both send data to the east output at the same time, thus causing a collision since neither instruction is part of a time-multiplexed fan-in instruction (such as the instruction 1078). To avoid potential collisions, certain embodiments use pre-processing, such as by a compiler, to arrange the instructions in such a way that there are no collisions when the instructions are loaded into the circular buffer. Thus, the circular buffer 1010 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the pre-processor can insert further instructions such as storage instructions (e.g. the instruction 1062), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that keeps track of the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will ensure that the memory bit is reset to 0 and will thereby prevent a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

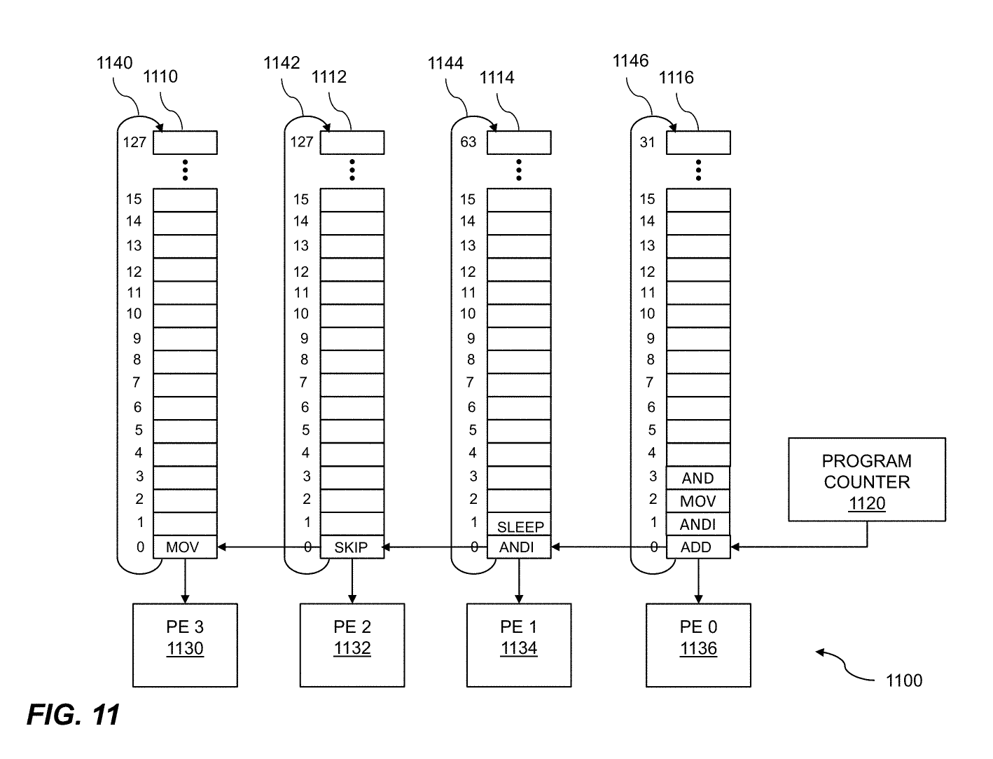

FIG. 11 shows example circular buffers and processing elements. This figure shows a diagram 1100 indicating example instruction execution for processing elements. A circular buffer 1110 feeds a processing element 1130. A second circular buffer 1112 feeds another processing element 1132. A third circular buffer 1114 feeds another processing element 1134. A fourth circular buffer 1116 feeds another processing element 1136. The four processing elements 1130, 1132, 1134, and 1136 can represent a quad of processing elements. In embodiments, the processing elements 1130, 1132, 1134, and 1136 are controlled by instructions received from the circular buffers 1110, 1112, 1114, and 1116. The circular buffers can be implemented using feedback paths 1140, 1142, 1144, and 1146, respectively. In embodiments, the circular buffer can control the passing of data to a quad of processing elements through switching elements, where each of the quad of processing elements is controlled by four other circular buffers (as shown in the circular buffers 1110, 1112, 1114, and 1116) and where data is passed back through the switching elements from the quad of processing elements where the switching elements are again controlled by the main circular buffer. In embodiments, a program counter 1120 is configured to point to the current instruction within a circular buffer. In embodiments with a configured program counter, the contents of the circular buffer are not shifted or copied to new locations on each instruction cycle. Rather, the program counter 1120 is incremented in each cycle to point to a new location in the circular buffer. The circular buffers 1110, 1112, 1114, and 1116 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the circular buffers 1110 and 1112 have a length of 128 instructions, the circular buffer 1114 has a length of 64 instructions, and the circular buffer 1116 has a length of 32 instructions, but other circular buffer lengths are also possible, and in some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 11, different circular buffers can have different instruction sets within them. For example, circular buffer 1110 contains a MOV instruction. Circular buffer 1112 contains a SKIP instruction. Circular buffer 1114 contains a SLEEP instruction and an ANDI instruction. Circular buffer 1116 contains an AND instruction, a MOVE instruction, an ANDI instruction, and an ADD instruction. The operations performed by the processing elements 1130, 1132, 1134, and 1136 are dynamic and can change over time, based on the instructions loaded into the respective circular buffers. As the circular buffers rotate, new instructions can be executed by the respective processing element.

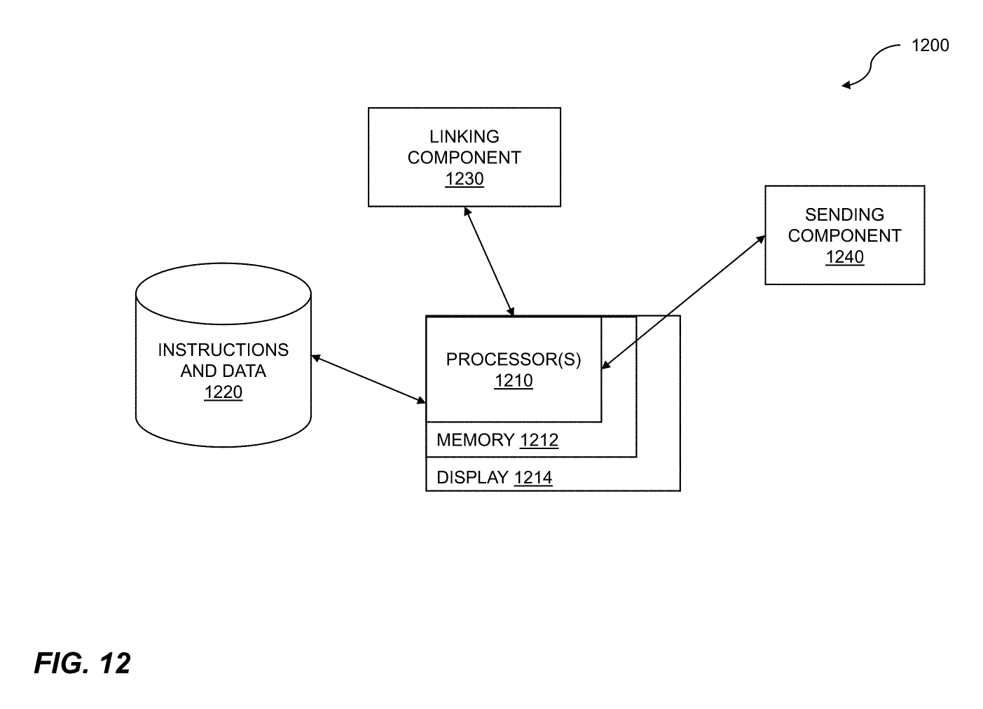

FIG. 12 is a system diagram for implementing transfers between agents in reconfigurable fabric. The system 1200 can include one or more processors 1210 coupled to a memory 1212 which stores instructions. The system 1200 can include a display 1214 coupled to the one or more processors 1210 for displaying data, intermediate steps, instructions, and so on. In embodiments, one or more processors 1210 attached to the memory 1212 where the one or more processors, when executing the instructions which are stored, are configured to: link a first control agent with a plurality of other control agents, wherein the first control agent and the plurality of other control agents are each executed on a processing element controlled by a circular buffer; send data from the first control agent to the plurality of other control agents, wherein: the data is sent to the plurality of other control agents in parallel; and employ a FIFO between the first control agent and the plurality of other control agents to facilitate the sending.

The system 1200 can include a collection of instructions and data 1220. The instructions and data 1220 may be stored in a database, one or more statically linked libraries, one or more dynamically linked libraries, precompiled headers, source code, flow graphs, or other suitable formats. System 1200 can include a linking component 1230. The linking component 1230 can include functions and instructions for linking a computing system comprising multiple processing elements that support fork operations. The linking can include establishing a mesh size, and/or establishing an initial placement of process agents. The system 1200 can include a sending component 1240. The sending component 1240 can include functions and instructions for establishing an initial size of one or more FIFOs. In embodiments, the sending component selects a first size for a first FIFO memory element and a second size for a second FIFO memory element.

The system 1200 shows a computer program product embodied in a non-transitory computer readable medium for data manipulation, the computer program product comprising code which causes one or more processors to perform operations. In embodiments, operations can include linking a first control agent with a plurality of other control agents, wherein the first control agent and the plurality of other control agents are each executed on a processing element controlled by a circular buffer. In other embodiments, operations can include the sending data from the first control agent to the plurality of other control agents, wherein: the data is sent to the plurality of other control agents in parallel; and a FIFO is employed between the first control agent and the plurality of other control agents to facilitate the sending.

Embodiments can include a computer system for data manipulation comprising: a memory which stores instructions; one or more processors attached to the memory wherein the one or more processors, when executing the instructions which are stored, are configured to: link a first control agent with a plurality of other control agents, wherein the first control agent and the plurality of other control agents are each executed on a processing element controlled by a circular buffer; send data from the first control agent to the plurality of other control agents, wherein: the data is sent to the plurality of other control agents in parallel; and a FIFO is employed between the first control agent and the plurality of other control agents to facilitate the sending.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application-specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for data manipulation comprising:
linking a first control agent with a plurality of other control agents, wherein the first control agent and the plurality of other control agents are each executed on a processing element controlled by a circular buffer, and wherein the processing elements comprise a reconfigurable fabric;
sending data from the first control agent to the plurality of other control agents, wherein:
the data is sent to the plurality of other control agents in parallel; and
a FIFO is employed between the first control agent and the plurality of other control agents to facilitate the sending.

2. The method of claim 1 wherein the sending includes transferring the data from a first control agent to the FIFO.

3. The method of claim 2 wherein the data that is transferred to the FIFO starts at a head address within the FIFO.

4. The method of claim 3 wherein the data that is transferred to the FIFO ends at a tail address within the FIFO.

5. The method of claim 4 wherein the head address and the tail address are different.

6. The method of claim 5 wherein the tail address is greater than the head address.

7. The method of claim 1 wherein the sending includes transferring the data from the FIFO to a second control agent, wherein the second control agent is part of the plurality of other control agents.

8. The method of claim 7 wherein the sending also includes transferring the data from the FIFO to a third control agent, wherein the third control agent is part of the plurality of other control agents.

9. The method of claim 8 wherein the data that is transferred from the FIFO to the second control agent starts at a first head address within the FIFO and ends at a first tail address within the FIFO.

10. The method of claim 9 wherein the data that is transferred from the FIFO to the third control agent starts at a second head address within the FIFO and ends at a second tail address within the FIFO.

11. The method of claim 10 wherein the first head address is the same as the second head address.

12. The method of claim 10 wherein the first tail address is the same as the second tail address.

13. The method of claim 10 wherein the first tail address is different from the second tail address.

14. The method of claim 10 wherein the first head address and the first tail address comprise pointers for the second control agent.

15. The method of claim 14 wherein the second head address and the second tail address comprise pointers for the third control agent.

16. The method of claim 15 wherein the pointers for the second control agent and the pointers for the third control agent are different.

17. The method of claim 8 further comprising receiving a first done signal by the first control agent from the second control agent, wherein the first done signal indicates the second control agent no longer needs the data in the FIFO.

18. The method of claim 17 further comprising receiving a second done signal by the first control agent from the third control agent, wherein the second done signal indicates the third control agent no longer needs the data in the FIFO.

19. The method of claim 18 further comprising sending subsequent data to the FIFO from the first control agent after the first done signal and the second done signal have been received.

20. The method of claim 8 further comprising sending a fire signal from the first control agent to the second control agent and the third control agent, wherein the fire signal indicates to the second control agent and the third control agent that the data in the FIFO is ready for use.

21. The method of claim 8 wherein the sending data comprises a fork operation.

22. The method of claim 8 wherein the FIFO comprises a first multicast FIFO and a second multicast FIFO, wherein:
data from the first control agent is sent to the first multicast FIFO and the second multicast FIFO in parallel;
data from the first multicast FIFO is sent to the second control agent using a first head address and a first tail address; and
data from the second multicast FIFO is sent to the third control agent using the first head address and a second tail address.

23. The method of claim 22 wherein the first tail address and the second tail address are different.

24. The method of claim 1 wherein the circular buffers are statically scheduled.

25. A computer program product embodied in a non-transitory computer readable medium for data manipulation, the computer program product comprising code which causes one or more processors to perform operations of:
linking a first control agent with a plurality of other control agents, wherein the first control agent and the plurality of other control agents are each executed on a processing element controlled by a circular buffer;
sending data from the first control agent to the plurality of other control agents, wherein: the data is sent to the plurality of other control agents in parallel; and a FIFO is employed between the first control agent and the plurality of other control agents to facilitate the sending.

26. A computer system for data manipulation comprising:
a memory which stores instructions;
one or more processors attached to the memory wherein the one or more processors, when executing the instructions which are stored, are configured to:
link a first control agent with a plurality of other control agents, wherein the first control agent and the plurality of other control agents are each executed on a processing element controlled by a circular buffer;
send data from the first control agent to the plurality of other control agents, wherein:
the data is sent to the plurality of other control agents in parallel; and
a FIFO is employed between the first control agent and the plurality of other control agents to facilitate the sending.
